(19) United States
(12) Patent Application Publication
(10) Pub. No.: US 2024/0072901 A1
(43) Pub. Date: Feb. 29, 2024

(54) MULTI-RATE OPTICAL TRANSCEIVER

(71) Applicant: EZCONN CORPORATION, New Taipei City (TW)

(72) Inventor: Chin Yin Lan, New Taipei City (TW)

(21) Appl. No.: 18/237,870

(22) Filed: Aug. 24, 2023

Related U.S. Application Data
(60) Provisional application No. 63/373,338, filed on Aug. 24, 2022.

(51) Int. Cl. H04B 10/40; G02B 6/42

(52) U.S. Cl. CPC H04B 10/40; G02B 6/4246; G02B 6/4277

(57) ABSTRACT

A multi-rate optical transceiver suitable for installation in a central office's host device is provided. The transceiver includes a rate selector, a first signal transceiver unit operating at a first transmission rate, a second signal transceiver unit operating at a second transmission rate, and a wavelength division multiplexing demultiplexer. The first signal transceiver unit comprises a first electro-optical converter and a first optoelectronic converter. The second signal transceiver unit comprises a second electro-optical converter and a second optoelectronic converter. The wavelength division multiplexing demultiplexer modulates the wavelengths of at least one of the optical signals from the first and second signal transceiver units into different frequency bands and combines them into grouped optical signals for external transmission. The use of this novel multi-rate optical transceiver enables convenient management of network rate switching and upgrades at the central office.

### RELATED APPLICATIONS

This application claims priority to U.S. Provisional Patent Application No. 63/373,338, filed on Aug. 24, 2022, which is incorporated herein by reference in its entirety.

### TECHNICAL FIELD

The present invention relates to an optical transceiver, particularly to a multi-rate optical transceiver.

### BACKGROUND

In the field of optical communication, optical transceivers have been crucial components of electro-optical conversion interfaces. The signal transmission rates have evolved from early 155 Mb/s to 512 Mb/s, and further escalated to 1 Gb/s to 10 Gb/s, or even higher, with various packaging forms adapted to different application environments. Examples include Small Form-Factor (SFF) Multi-Sourcing Agreements (MSAs), Small Form-Factor Pluggable (SFP) MSAs, XENPAK MSAs, X2 MSAs, and SFP+ MSAs, which define packaging dimensions for electronic modules. The benefits of pluggable module packaging are low cost, standardization, and interoperability, leading to their widespread use in the market.

FIG. 1 is a schematic diagram of a conventional optical fiber communication system transmitting information from a central office (CO) to a destination using optical fibers as communication channels. For instance, one of the interface ports 91 in the host device 901 located at the central office 900 is configured for electrical connection to an optical transceiver 902 with a transmission rate of 2.5 Gb/s. The optical transceiver 902 converts electrical signals to optical signals and uses a 1550 nm wavelength for data transmission through an optical fiber cable as a communication channel, with 1310 nm wavelength for data reception. Consequently, a user terminal device 801 located at the customer premise 800 needs an optical transceiver 802 with a transmission rate of 2.5 Gb/s. This optical transceiver 802 receives data from the central office 900 at a 1550 nm wavelength and transmits data to the central office 900 at a 1310 nm wavelength, thus enabling a point-to-point bidirectional data transmission telecommunication network.

Since existing optical transceivers 902 have only one transmission rate, when the user terminal 800 requests a transmission rate upgrade at the central office 900, manual disassembly and replacement of the lower-rate optical transceiver 902 from the host device 901, followed by installation of a higher-rate optical transceiver 902, are required to complete the upgrade operation. Additionally, if the optical transceiver 802 at the user terminal 800 cannot match the upgraded transmission rate, the user needs to separately purchase an optical transceiver suitable for the corresponding upgraded transmission rate.

As evident, whenever the user terminal 800 requires a change in transmission rate, the central office 900 is compelled to frequently dispatch engineers to the equipment room or even to the user terminal 800 for manual replacement and installation of optical transceivers. Moreover, due to the increasing demand for high-speed data transmission, the quantity and density of optical transceivers that can be accommodated by the host device 901 have significantly increased, making insertion and removal operations of optical transceivers more challenging and inconvenient.

### SUMMARY

Therefore, the objective of the present invention is to provide a multi-rate optical transceiver capable of addressing at least one drawback in the prior art.

Accordingly, the novel multi-rate optical transceiver includes a rate selector, multiple signal transceiver units, and a wavelength division multiplexing demultiplexer.

The rate selector is employed to switch between different transmission rates. The signal transceiver units are coupled to the rate selector and include a first signal transceiver unit operating at a first transmission rate and a second signal transceiver unit operating at a second transmission rate, wherein the first transmission rate is distinct from the second transmission rate. The first signal transceiver unit comprises a first electro-optical converter for converting electrical signals to optical signals and a first optoelectronic converter for converting optical signals to electrical signals. The second signal transceiver unit comprises a second electro-optical converter for converting electrical signals to optical signals and a second optoelectronic converter for converting optical signals to electrical signals. The wavelength division multiplexing demultiplexer is coupled to the signal transceiver units and modulates the wavelengths of at least one of the optical signals from the signal transceiver units into different frequency bands and combines them into grouped optical signals for external transmission.

Another objective of the present invention is to provide a network communication system employing the above-mentioned multi-rate optical transceiver.

The network communication system using the multi-rate optical transceiver includes a host device, at least one multi-rate optical transceiver, and a user terminal device.

The host device comprises multiple interfaces. The at least one multi-rate optical transceiver is installed at one of the interfaces of the host device. The at least one multi-rate optical transceiver includes a rate selector for switching between different transmission rates, multiple signal transceiver units coupled to the rate selector, and a wavelength division multiplexing demultiplexer coupled to the said signal transceiver units. The signal transceiver units comprise a first signal transceiver unit with a first transmission rate and a second signal transceiver unit with a second transmission rate, wherein the first transmission rate is distinct from the second transmission rate. The first signal transceiver unit includes a first electro-optical converter (electrical-to-optical converter, EO) for converting electrical signals to optical signals, and a first optoelectronic converter (optical-to-electrical converter, OE) for converting optical signals to electrical signals. The second signal transceiver unit includes a second electro-optical converter and a second optoelectronic converter. The wavelength division multiplexing demultiplexer modulates the wavelengths of at least one of the optical signals from the signal transceiver units into different frequency bands and superimposes them into grouped optical signals for external transmission.

The user terminal device is coupled to the at least one multi-rate optical transceiver installed in the host device via optical fiber cables. The user terminal device comprises an optical demultiplexer and a user-end optical transceiver interconnected to each other.

The following detailed description of illustrative embodiments, accompanying drawings, and the scope of patent application will clarify the components, steps, features, advantages, and benefits of this invention.

The above and other components, steps, features, advantages, and benefits of the present invention will become clear through the detailed description of exemplary embodiments, accompanying drawings, and the claims of the application.

### BRIEF DESCRIPTION OF THE DRAWINGS

Unless specified otherwise, the accompanying drawings illustrate aspects of the innovative subject matter described herein. Referring to the drawings, wherein like reference numerals indicate similar parts throughout the several views, several examples of coaxial cable connector incorporating aspects of the presently disclosed principles are illustrated by way of example, and not by way of limitation.

Other features and advantages of the present invention will become apparent from the following detailed description of illustrative embodiments with reference to the drawings, in which:

FIG. 1 is a schematic diagram of a conventional communication system illustrating the use of optical fiber cables as communication channels between a central office and a destination, utilizing single-rate optical transceivers;

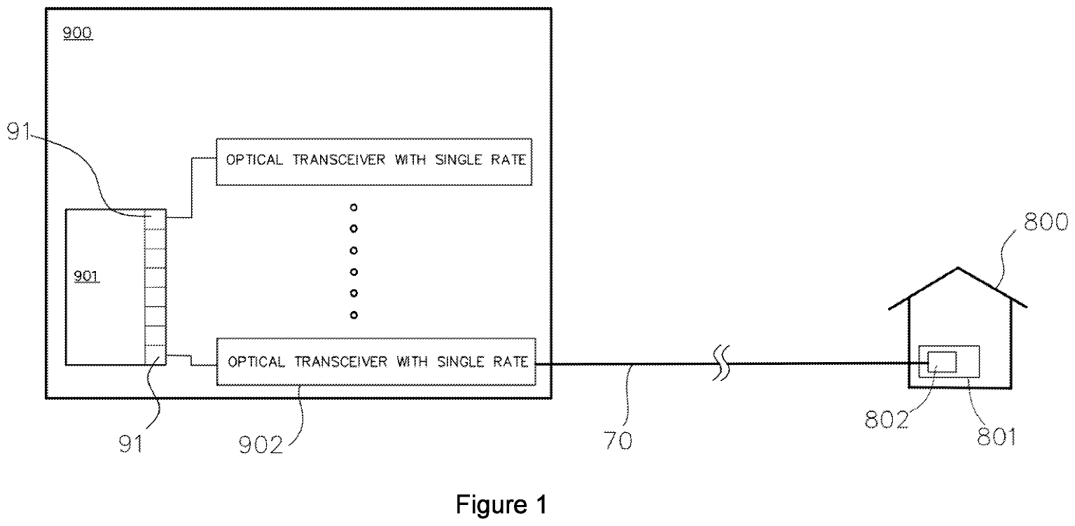

FIG. 2 is a schematic diagram of an embodiment of the novel multi-rate optical transceiver, illustrating its application at a central office;

FIG. 3 is a block diagram of this embodiment, illustrating its electrical connection to a host device; and

FIG. 4 is a block diagram of this embodiment demonstrating variations in transmission rates, illustrating the variant pattern in connection with a host device.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings but are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

Before describing the present invention in detail, it should be noted that similar elements are denoted by the same reference numerals in the following description. Furthermore, the shapes, dimensions, thicknesses, angles, and other related parameters of components in the drawings are not drawn to scale; their simplification aims to facilitate clear explanation.

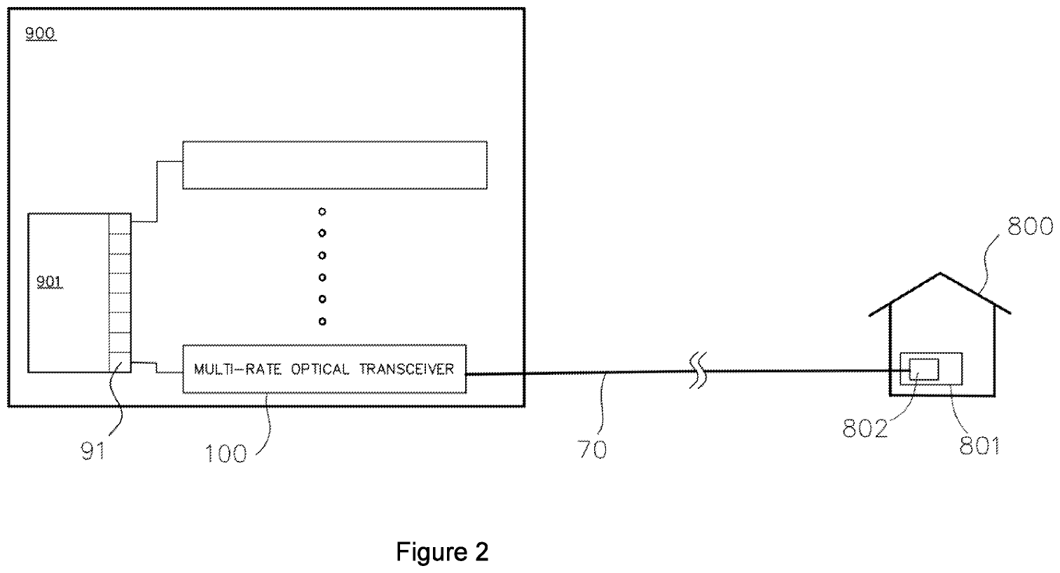

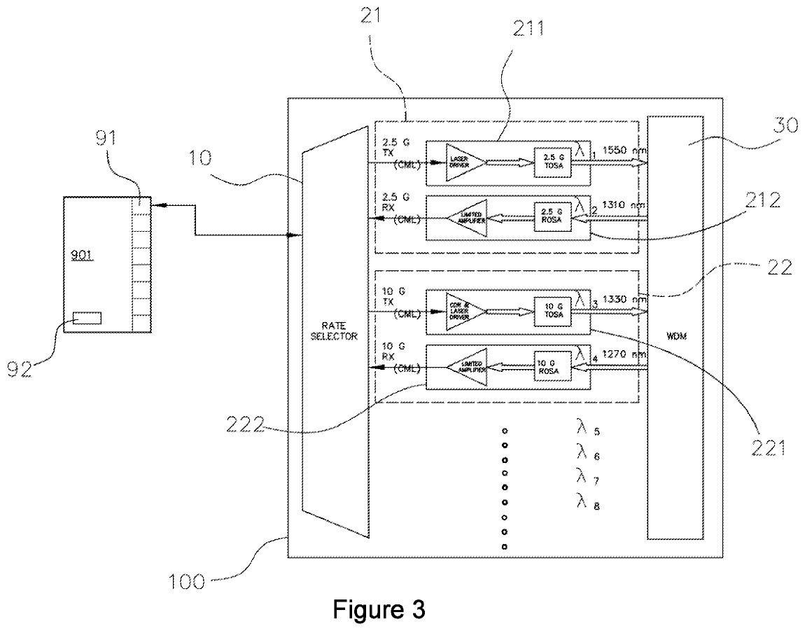

Referring to FIGS. 2 and 3, an embodiment of the novel multi-rate optical transceiver 100 is suitable for installation at the interface 91 of the host device 901. In some embodiments, the multi-rate optical transceiver 100 can be installed on the user terminal device 801 at the user terminal 800, replacing the traditional single-rate optical transceiver 802 as depicted in FIG. 2.

The novel multi-rate optical transceiver 100 comprises a rate selector 10, multiple signal transceiver units with varying transmission rates, and a wavelength division multiplexing demultiplexer 30, which are electrically interconnected or coupled.

The rate selector 10, for example, could be a radio frequency switch (RF switch), a microwave switch, or a controllable element or circuit allowing signals to pass through specific paths. In this embodiment, the RF switch supports transmission rates from 1 Gb/s to 10 Gb/s, or even higher. The supported transmission rate categories include 1 Gb/s, 2.5 Gb/s, 4.25 Gb/s, 10 Gb/s, 25 Gb/s, and 50 Gb/s, thus enabling switching between different high-speed signal types.

In this embodiment, the signal transceiver units can be defined as a first signal transceiver unit 21 operating at a first transmission rate and a second signal transceiver unit 22 operating at a second transmission rate, wherein the first transmission rate is different from the second transmission rate.

The first signal transceiver unit 21 comprises a first electro-optical converter 211 (electrical-to-optical converter, EO) and a first optoelectronic converter 212 (optical-to-electrical converter, OE). The first electro-optical converter 211 includes a laser driver and a transmitter optical sub-assembly (TOSA), operating at a first wavelength λ1 corresponding to the first transmission rate. The first optoelectronic converter 212 includes a limited amplifier and a receiver optical sub-assembly (ROSA), operating at a second wavelength λ2 corresponding to the first transmission rate. The second signal transceiver unit 22 comprises a second electro-optical converter 221 and a second optoelectronic converter 222. The second electro-optical converter 221 includes a laser driver and a TOSA, operating at a third wavelength λ3 corresponding to the second transmission rate. The second optoelectronic converter 222 includes a limited amplifier and a ROSA, operating at a fourth wavelength λ4 corresponding to the second transmission rate.

The wavelength division multiplexing demultiplexer 30 is coupled to multiple signal transceiver units and, in particular, optically coupled to TOSAs operating at the first wavelength λ1, ROSAs operating at the second wavelength λ2, TOSAs operating at the third wavelength λ3, and ROSAs operating at the fourth wavelength λ4. In this embodiment, the first wavelength λ1, second wavelength λ2, third wavelength λ3, and fourth wavelength λ4 are distinct from each other. The wavelength division multiplexing demultiplexer 30 modulates different wavelengths into distinct frequency bands and then superimposes them to form grouped optical signals for transmission on specified optical channels.

Hereinafter, a preferred embodiment of the multi-rate optical transceiver having two transmission rates will be described:

Referring to FIGS. 2 and 3, one of the interfaces 91 of the host device 901 of the central office 900 is electrically connected to the multi-rate optical transceiver 100 having two transmission rates, namely 2.5 Gb/s and 10 Gb/s. During operation, the rate selector 10 in the multi-rate optical transceiver 100 selectively opens a connection to either the first signal transceiver unit 21 with the first transmission rate or the second signal transceiver unit 22 with the second transmission rate, based on the first electrical signal from the host device 901. In some embodiments, the host device 901 may be configured to apply a high voltage level to the first electrical signal and a low voltage level to the second electrical signal, thereby enabling the selection of different transmission rates through an interface switch provided on the operational panel of the host device 901.

When the transmission rate of 2.5 Gb/s is chosen, the laser driver within the first electro-optical converter 211 converts the data from the central office 900 into optical form from its electrical signal form. The first wavelength, 1550 nm, is transmitted from the TOSA to the wavelength division multiplexing demultiplexer 30, then through the optical fiber cable 70 to the customer premises 800. At the customer premises 800, a reverse demultiplexing process is performed, executed by a demultiplexer located in the customer premises 800. The demultiplexer receives optical signals from the wavelength division multiplexing demultiplexer and separates them into individual original (or low-frequency) optical signals, allowing the customer-side optical transceiver 801 installed on the user terminal equipment 801 to accurately receive data at a wavelength of 1550 nm.

When the user terminal 800 uploads data through the customer-side optical transceiver, the data is transmitted through the optical fiber cable 70 in the form of a wavelength of 1310 nm to the multi-rate optical transceiver 100 of the central office 900. Subsequently, in the first optoelectronic converter 212 within the multi-rate optical transceiver 100, the ROSA converts the 1310 nm wavelength optical signal into an electrical signal, which then passes through a limiting amplifier, the rate selector 10, and reaches the host device 901. Preferably, a microcontroller 92 in the host device 901 provides registers to collect and store parameters such as operational temperatures, optoelectronic currents, optical intensities, laser powers, and the like, particularly related to the TOSA/ROSA.

In some embodiments, the multi-rate optical transceiver further includes an optical detector electrically connected to the rate selector 10 for measuring the wavelength distribution of light. Based on the results from the optical detector, the multi-rate optical transceiver can dynamically switch the path (or channel) connected to the signal transceiver units within the rate selector 10, according to the received external wavelength. For instance, if the multi-rate optical transceiver is initially set to receive an external light wavelength of 1310 nm but the actual received wavelength is determined as 1270 nm by the optical detector, the rate selector 10 automatically switches from the mode connected to the first signal transceiver unit 21 to the mode of the second signal transceiver unit 22, corresponding to the actual received wavelength, enabling the optical signals to be transformed into electrical signals upon entering the host device 901.

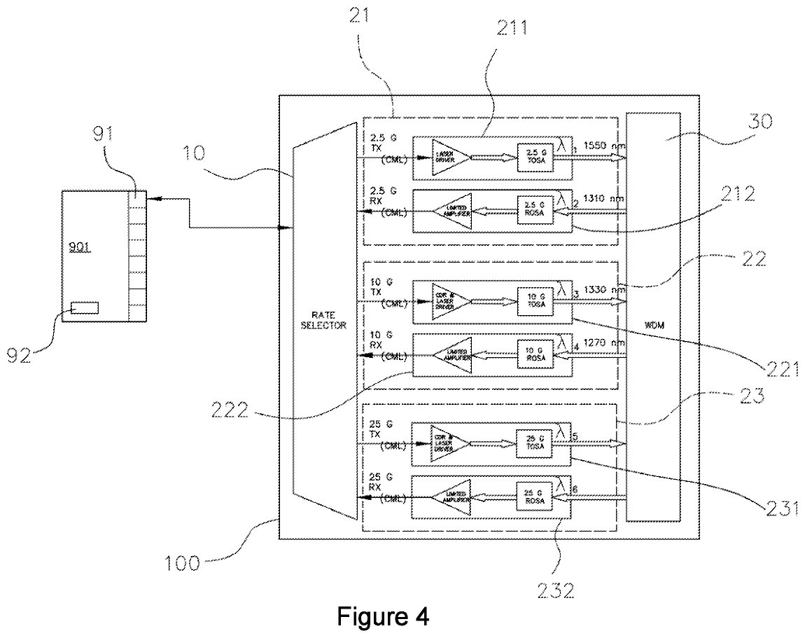

In some embodiments, the multi-rate optical transceiver comprises more than two transmission rates, for example, a multi-rate optical transceiver with three different transmission rates (as shown in FIG. 4). This embodiment includes a third signal transceiver unit 23 with a third transmission rate. The third signal transceiver unit 23 comprises a third electro-optical converter 231 and a third optoelectronic converter 232. The third electro-optical converter 231 includes a laser driver and an optical transmitter subassembly that operates at a third wavelength, λ5, for the third transmission rate. The third optoelectronic converter 232 includes a limiting amplifier and an optical receiver subassembly that operates at a fourth wavelength, λ6, for the third transmission rate. The wavelength division multiplexing demultiplexer 30 is further coupled to the third signal transceiver unit 23, particularly optically coupled to the TOSA operating at the fifth wavelength, λ5, and the ROSA operating at the sixth wavelength, λ6, where the first wavelength, λ1, the second wavelength, λ2, the third wavelength, λ3, the fourth wavelength, λ4, the fifth wavelength, λ5, and the sixth wavelength, λ6, are distinct from each other.

In some embodiments, the present multi-rate optical transceiver not only complies with the Multi-Source Agreement (MSA) but also possesses plug-and-play functionality, making it widely compatible with existing equipment in the market. Furthermore, the present multi-rate optical transceiver can be customized in mechanical, electrical, or optical characteristics to meet specific user requirements.

In some embodiments, the present multi-rate optical transceiver can be employed in various applications, including high-speed I/O for servers, I/O for high-capacity storage systems, bus expansion applications, FTTx applications, and 1× optical fiber channel applications.

In some embodiments, the present multi-rate optical transceiver can simultaneously support IEEE802.3 2.5GBase-BX20-D and IEEE802.3 10GBase-BX20-D standards; it utilizes distributed feedback transmitters (DFB transmitters) operating at 1550 nm and 1330 nm; it employs PIN-TIA receivers operating at 1310 nm and 1270 nm; it offers TX/RX data rates of 2.5 Gbps and 10 Gbps; it conforms to the digital diagnostics function of SFF-8472; it is packaged in an SFP+ form factor with SC/UPC connectors; it operates within a temperature range of −40° C. to 85° C.; it complies with Class 1 laser safety requirements; and it adheres to SFF-8432 and SFF-8472 standards.

While the present multi-rate optical transceiver has been disclosed with embodiments illustrating transmission rates of 2.5 Gb/s and 10 Gb/s, along with optical wavelengths of 1550 nm and 1330 nm, it is not limited thereto. Those skilled in the art would appreciate that the embodiments disclosed in this disclosure can be adapted, using corresponding optical wavelengths (not limited to the disclosed 1550 nm and 1330 nm wavelengths), to achieve the effects and objectives of the present invention at different practical transmission rates (such as 1 Gb/s, 4.25 Gb/s, 25 Gb/s, and 50 Gb/s, among others).

Based on the above description, the advantages of the present multi-rate optical transceiver can be summarized as follows:

1. When the present multi-rate optical transceiver is used in the central office, changing the rate option on the host device or achieving rate transition through a dynamic auto-switching mechanism is sufficient to alter the transmission rate. There is no need to manually dismantle the optical transceiver during rate upgrades or adjustments, thereby improving convenience and eliminating the drawback of manual replacement of optical transceivers traditionally required for rate upgrades.

2. The present multi-rate optical transceiver enables the central office network communication system to conveniently expand from lower transmission rates like 1 Gb/s to higher rates such as 10 Gb/s or even greater rates like 25 Gb/s or above, enhancing the simplicity of upgrading network speeds.

The presently disclosed inventive concepts are not intended to be limited to the embodiments shown herein, but are to be accorded their full scope consistent with the principles underlying the disclosed concepts herein. Directions and references to an element, such as “up,” “down,”, “upper,” “lower,” “horizontal,” “vertical,” “left,” “right,” and the like, do not imply absolute relationships, positions, and/or orientations. Terms of an element, such as “first” and “second” are not literal, but, distinguishing terms. As used herein, terms “comprises” or “comprising” encompass the notions of “including” and “having” and specify the presence of elements, operations, and/or groups or combinations thereof and do not imply preclusion of the presence or addition of one or more other elements, operations and/or groups or combinations thereof. Sequence of operations do not imply absoluteness unless specifically so stated. Reference to an element in the singular, such as by use of the article “a” or “an”, is not intended to mean “one and only one” unless specifically so stated, but rather “one or more”. As used herein, “and/or” means “and” or “or”, as well as “and” and “or.” As used herein, ranges and subranges mean all ranges including whole and/or fractional values therein and language which defines or modifies ranges and subranges, such as “at least,” “greater than,” “less than,” “no more than,” and the like, mean subranges and/or an upper or lower limit. All structural and functional equivalents to the elements of the various embodiments described throughout the disclosure that are known or later come to be known to those of ordinary skill in the relevant art are intended to be encompassed by the features described and claimed herein. Moreover, nothing disclosed herein is intended to be dedicated to the public regardless of whether such disclosure may ultimately explicitly be recited in the claims. No element or concept disclosed herein or hereafter presented shall be construed under the provisions of 35 USC 112(f) unless the element or concept is expressly recited using the phrase “means for” or “step for”.

In view of the many possible embodiments to which the disclosed principles can be applied, we reserve the right to claim any and all combinations of features and acts described herein, including the right to claim all that comes within the scope and spirit of the foregoing description, as well as the combinations recited, literally and equivalently, in the following claims and any claims presented anytime throughout prosecution of this application or any application claiming benefit of or priority from this application.

What is claimed is:

1. A multi-rate optical transceiver comprising:
a rate selector, configured to switch between different transmission rates;
a plurality of signal transceiver units, coupled to said rate selector and comprising a first signal transceiver unit operating at a first transmission rate and a second signal transceiver unit operating at a second transmission rate, wherein the first transmission rate is distinct from the second transmission rate, said first signal transceiver unit comprising a first electro-optical converter for converting electrical signals to optical signals and a first optoelectronic converter for converting optical signals to electrical signals, said second signal transceiver unit comprising a second electro-optical converter for converting electrical signals to optical signals and a second optoelectronic converter for converting optical signals to electrical signals; and
a wavelength division multiplexing demultiplexer, coupled to said signal transceiver units and configured to modulate wavelengths of at least one of the optical signals from said signal transceiver units into different frequency bands which combined into grouped optical signals for external transmission.

2. The multi-rate optical transceiver of claim 1, wherein said first electro-optical converter comprises a laser driver and an optical emitting submodule operating at a first wavelength, and said first optoelectronic converter comprises a limiting amplifier and an optical receiving submodule operating at a second wavelength different from said first wavelength.

3. The multi-rate optical transceiver of claim 2, wherein said second electro-optical converter comprises a laser driver and an optical emitting submodule operating at a third wavelength, and said second optoelectronic converter comprises a limiting amplifier and an optical receiving submodule operating at a fourth wavelength, wherein said first wavelength, said second wavelength, said third wavelength, and said fourth wavelength are distinct from each other.

4. The multi-rate optical transceiver of claim 1, wherein said rate selector is selected from a group consisting of a radio frequency switch, a microwave switch, a controllable element allowing signal passage through specific paths, or a circuit.

5. The multi-rate optical transceiver of claim 1, wherein said signal transceiver units further comprise a third signal transceiver unit operating at a third transmission rate, wherein said first transmission rate, said second transmission rate, and said third transmission rate are distinct from each other, said third signal transceiver unit comprising a third electro-optical converter for converting electrical signals to optical signals and a third optoelectronic converter for converting optical signals to electrical signals.

6. The multi-rate optical transceiver of claim 1, further comprising an optical detector for measuring wavelength distribution of light, said optical detector electrically connected to said rate selector.

7. A network communication system employing a multi-rate optical transceiver, comprising:
a host device comprising multiple interfaces;
at least one multi-rate optical transceiver installed in one of said interfaces of said host device, said at least one multi-rate optical transceiver comprising:
a rate selector configured to switch between different transmission rates;
multiple signal transceiver units coupled to said rate selector, said signal transceiver units comprising a first signal transceiver unit operating at a first transmission rate and a second signal transceiver unit operating at a second transmission rate, wherein the first transmission rate is distinct from the second transmission rate, said first signal transceiver unit comprising a first electro-optical converter for converting electrical signals to optical signals and a first optoelectronic converter for converting optical signals to electrical signals, said second signal transceiver unit comprising a second electro-optical converter for converting electrical signals to optical signals and a second optoelectronic converter for converting optical signals to electrical signals; and
a wavelength division multiplexing demultiplexer coupled to said signal transceiver units and configured to modulate wavelengths of at least one of the optical signals from said signal transceiver units into different frequency bands which combined into grouped optical signals for external transmission; and
a user terminal device connected via an optical fiber cable and coupled to said at least one multi-rate optical transceiver, said user terminal device comprising an optical demultiplexer and a user-side optical transceiver.

8. The network communication system of claim 7, wherein said user-side optical transceiver is a multi-rate optical transceiver.

9. The network communication system of claim 7, wherein said host device further comprises an operating panel configured for selecting output of a first electrical signal corresponding to said first transmission rate or a second electrical signal corresponding to said second transmission rate.

10. The network communication system of claim 7, wherein said multi-rate optical transceiver is removably installed in said interface of said host device.
